(19) United States
(12) Patent Application Publication
(10) Pub. No.: US 2026/0255183 A1
(43) Pub. Date: Aug. 27, 2026

(54) METHODS FOR ANTENNA ADJUSTMENT

(71) Applicant: T-Mobile Innovations LLC, Overland Park, KS (US)

(72) Inventor: Timur KOCHIEV, Irvine, CA (US)

(21) Appl. No.: 19/065,103

(22) Filed: Feb. 27, 2025

(51) Int. Cl. H04W 24/02; H01Q 1/12

(52) U.S. Cl. CPC H04W 24/02; H01Q 1/1257

(57) ABSTRACT

Methods are provided for receiving a radiofrequency parameter corresponding to a wireless aerial device at an access node, determining that the radiofrequency parameter satisfies a threshold, and adjusting a tilt angle of at least one antenna of a radio access network (RAN) in response to determining that the radiofrequency parameter satisfies a threshold.

### TECHNICAL BACKGROUND

Aerial devices, such as drones, are increasingly used in commercial contexts. In some examples, the aerial device may include cellular connectivity functionality, such as a 4G or a 5G modem. Such connectivity may enhance the flying capabilities of the aerial device beyond the functionality provided by the global position system (GPS) functionality of the device. For example, cellular connectivity may permit live video of the area the aerial device is flown over. In circumstances where the aerial device is being used for, e.g., infrastructure inspection, real estate video recording, mapping, or surveillance, uninterrupted cellular connectivity is important for the video to be continuous and maintain image quality. However, cellular coverage often weakens as altitude increases, resulting in the potential for the aerial device to experience lower connectivity as its altitude increases.

### OVERVIEW

Exemplary embodiments described herein include methods for antenna adjustment. An exemplary method includes receiving a radiofrequency parameter at an access node. The radiofrequency parameter may correspond to a wireless aerial device. The method then includes determining that the radiofrequency parameter is at a threshold. In response to the determination that the radiofrequency parameter satisfies a threshold, the method includes adjusting a tilt angle of at least one antenna. The at least one antenna may be part of a radio access network (RAN).

Another example method includes determining that an antenna is in a first orientation. The method then includes receiving one or more radiofrequency parameters corresponding to one or more wireless aerial devices. The radiofrequency parameters may be received at an access node. Upon receiving the one or more radiofrequency parameters, the method includes determining that the one or more radiofrequency parameters satisfy a threshold. The method continues with adjusting a tilt angle of the antenna to a second orientation from the first orientation. The adjustment of the tilt angle occurs in response to the determination that the one or more radiofrequency parameters satisfy the threshold radiofrequency parameter.

Another example method includes connecting, by a wireless aerial device at a first altitude, to an antenna. The antenna is in a first orientation. The method then includes moving, at the wireless aerial device, from the first altitude to a second altitude. In response to moving to the second altitude from the first altitude, the method includes connecting to an antenna in a second orientation.

### BRIEF DESCRIPTION OF THE DRAWINGS

FIG. 1 illustrates an exemplary system for wireless aerial device communication in accordance with disclosed embodiments.

FIG. 2 illustrates an example method for antenna adjustment in accordance with disclosed embodiments.

FIG. 3 illustrates another example method for antenna adjustment in accordance with disclosed embodiments.

FIG. 4 illustrates another example method for antenna adjustment in accordance with disclosed embodiments.

FIG. 5 illustrates an exemplary aerial device in accordance with disclosed embodiments.

FIG. 6 illustrates an example of a computing device in accordance with aspects of this disclosure.

### DETAILED DESCRIPTION

Aerial devices, and particularly wireless aerial devices, such as autonomous drones, are increasingly being used in industrial and commercial contexts. These contexts may include inspections of industrial buildings and bridges, commercial delivery of cargo, video recording for real estate, mapping, and surveillance, among others. Many aerial devices now include connectivity features, such as a modem, to allow the device to connect to a cellular network. This cellular connectivity extends and enhances the flight capabilities of the aerial device beyond the location-based global positioning system (GPS) within the aerial device. For example, cellular connectivity, and particularly 5G connectivity, can allow live video streaming between the aerial device and an operator on the ground. In addition, having cellular connection capabilities on the aerial device can improve communication between the aerial device and the operator. The operator can send commands to the aerial device with low latency, allowing the aerial device to quickly receive and respond to the command, resulting in greater flight stability and precision. In addition, use of cellular connectivity allows continued use of the aerial device in areas where GPS functionality is lessened or restricted.

Aerial devices that use cellular connectivity do so by connecting to a wireless network, and more particularly to a base station that is part of a radio access network (RAN). The RAN includes at least one telecommunications antenna that transmits radio waves, which can be used for cellular communications. By providing a series of telecommunications antennas at a RAN, a wireless network is able to provide coverage across a cell area. Each antenna may be movable, or tiltable, between a variety of positions, with the angle of the antenna serving to help direct the radio waves.

More particularly, telecommunications antennae that are part of a RAN are often tilted in a generally downward direction, towards ground users and building users. This allows users located on the ground and in lower to middle levels of buildings to receive stronger cellular signals and thus greater connectivity. When buildings extend higher than about fifteen floors, smaller cells may be integrated into the building to handle users in the building in the higher floors, allowing the telecommunications antennae to be focused on the lower floors and ground, where there are the greatest number of cellular device users.

However, certain aerial devices, such as drones, can be used above these heights, with some drones capable of reaching altitudes of between four hundred and five hundred feet. Such devices may be referred to as “high altitude device”. Some high altitude devices may be equipped with cellular connectivity; as such, the device may connect with the cellular network provided by the RAN. When the high altitude device is relatively near the ground, the cellular connection is generally strong because the telecommunications antennae that are part of the RAN are angled towards the ground to maximize coverage and connection for users. As the aerial device increases in altitude, however, coverage may wane due to the angle of the antennae. As such, communication between the aerial device and a controller, which may rely on a cellular connection, may be interrupted or delayed. In addition, if the aerial device is sending video or photographs to the user and/or communicating with the internet, slower or weaker connections may result in a delay.

Exemplary embodiments described herein relate to adjustment of antennae in an RAN. For example, when a wireless aerial device connects with an antenna, the device may send information, or a radiofrequency parameter, to an access node associated with the antenna. The parameter may include identification information to identify the wireless aerial device and/or information about the location of the device (e.g., the device’s altitude). Upon receiving the parameter at the access node, the parameter may be compared with a threshold for one or more parameters. For instance, in examples where the parameter includes altitude information, the device’s current altitude may be compared to a threshold altitude above which the cellular signal is likely to be affected. When the parameter is determined to meet the threshold, a tilt angle of at least one antenna associated with the RAN may be adjusted. More particularly, the tilt angle may be moved from generally downward facing to more upward facing, such that the antenna transmits radio waves in a corresponding direction. This may allow the aerial device to maintain strong cellular connectivity as the device increases in altitude.

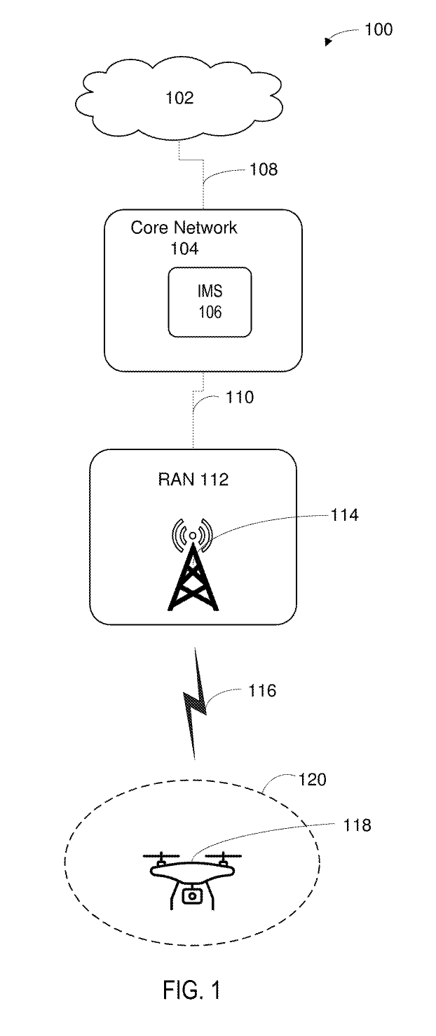

These and other examples will be described in greater detail below in relation to FIGS. 1-6.

FIG. 1 depicts an exemplary system 100 for wireless communication. System 100 includes a communication network 102, a core network 104 and a radio access network (RAN) 112, including at least one access node 114. The RAN 112 may include other devices and additional access nodes. Although one access node is shown, any number of access nodes may be included.

System 100 also includes a wireless aerial device 118, which may be an end-user device and may operate within a coverage area 120. The wireless aerial device 118 may communicate with an access node 114 within the RAN 112 over a communication link 116.

Communication network 102 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 102 can be capable of carrying data, for example, to support voice, push-to-talk, broadcast video, and data communications by wireless device 118. Wireless network protocols can comprise Fifth Generation mobile networks or wireless systems (4G or 4G LTE) or 5G. Wired network protocols that may be utilized by communication network 102 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 102 can also comprise additional base stations, controller nodes, telephony switches, internet routers, network gateways, computer systems, communication links, or some other type of communication equipment, and combinations thereof.

The core network 104 includes the IP Multimedia Subsystem (IMS) 106. The core network 104 may be separated into user plane functions and control plane functions. The user plane accesses a data network, such as network 102, and performs operations such as packet routing and forwarding, packet inspection, policy enforcement for the user plane, quality of service (QoS) handling, etc. The control plane handles radio-specific functionality that depends on the idle or connected states of the wireless aerial device 118.

Core network 104 may include an IP multimedia subsystem (IMS) 106. IMS 106 as used herein is a framework used for delivering IP multimedia services, such as voice over internet protocol (VoIP) and/or other similar services, across a network. IMS 106 may include a call session control function (CSCF). The CSCF as used herein is a component of IMS 106 used for session control, signaling and routing in multimedia communication. In embodiments, the CSCF may be used for handling session initiation protocol (SIP) communication. In embodiments, IMS 106 may be used for communication between entities or components of network 102 and wireless device 118. For example, the CSCF of the IMS 106 may be used for communication between wireless aerial device 118 and a user. Communication links 108 and 110 can use various communication media, such as air, space, metal, optical fiber, or some other signal propagation path - including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format - including combinations, improvements, or variations thereof. Wireless communication links may use electromagnetic waves in the radio frequency (RF), microwave, infrared (IR), or other wavelength ranges, and may use a suitable communication protocol, including 4G including 4G NR or 4G Advanced, 6G, NTN, or combinations thereof.

Communication links 108 and 110 can be direct links or might include various equipment, intermediate components, systems, and networks, such as a cell site router, etc. Communication links 108 and 110 may comprise many different signals sharing the same link.

The RAN 112 may include an access network system and device such as access node 114. The RAN 112 is disposed between the core network 104 and the wireless aerial device 118. Components of the RAN 112 may communicate directly with the core network 104 and others may communicate directly with the wireless aerial device 118. The RAN 112 may provide services from the core network 104 to the wireless aerial device 118.

The RAN 112 includes an access node (or base station) 114, which may include one or more access nodes communicating with the wireless aerial device 118. It should be understood that the disclosed technology may also be applied to communication between a wireless aerial device and other network resources, such as relay nodes, controller nodes, antennas, etc. The RAN 112 may further comprise a non-terrestrial network (NTN) serving the multiple UEs by a radio frequency transmission provided by utilizing orbiting satellites that may be in communication with access nodes of a terrestrial network (TN). The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access node 114 can be, for example, standard access nodes such as a macro-cell access node, a base transceiver station, a radio base station, such as an evolved NodeB (or eNodeB) in 4G or 4G LTE, a next generation NodeB (or gNodeB) in 5G New Radio (“5G NR”), or other generations of radio base station nodes. In some embodiments, access node 114 may include at least one antenna which transmits cellular signals. In additional embodiments, access nodes may comprise two co-located cells, or antenna/transceiver combinations that are mounted on the same structure. Alternatively, access node 114 may comprise a short range, low power, small-cell access node such as a microcell access node, a picocell access node, a femtocell access node. Access node 114 can be configured to deploy one or more different carriers, utilizing one or more RATs. Any other combination of access nodes and carriers deployed therefrom may be evident to those having ordinary skill in the art in light of this disclosure.

The access node 114 and servers in the IMS 106 may comprise a processor and associated circuitry to execute or direct the execution of computer-readable instructions. They may retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless aerial device 118 may include any wireless aerial device included in a wireless network. For example, the term “wireless device” may include a relay node, which may communicate with an access node. The term “wireless device” may also include an end-user wireless device, which may communicate with the access node through a relay node. The term “wireless device” may further include an end-user wireless device that communicates with the access node directly without being relayed by a relay node. Wireless device 118 may be any device, system, combination of devices, or other such communication platform capable of communicating wirelessly with access node 114 using one or more frequency bands and wireless carriers deployed therefrom. Wireless aerial device 118 may be, for example, a drone, an internet of things (IoT) device, as well as other types of devices or systems that can send and receive audio or data. The wireless aerial device 118 may be or include high power wireless devices or standard power wireless devices.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by wireless aerial device 118.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the RAN 112 and the core network 104.

Although one core network 104 is shown, multiple core networks 104 may be utilized. Alternatively, the single core network 104 may include a distributed, cloud-native, converged core gateway. Thus, the converged core gateway could connect a 4G LTE evolved packet core (EPC) to a 5G core network.

Communication links 108 and 110 can use various communication media, such as air, space, metal, optical fiber, or some other signal propagation path, including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format - including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 108 and 110 can be direct links or might include various equipment, intermediate components, systems, and networks, such as a cell site router, etc. Communication links 108 and 110 may comprise many different signals sharing the same link.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for antenna adjustment may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

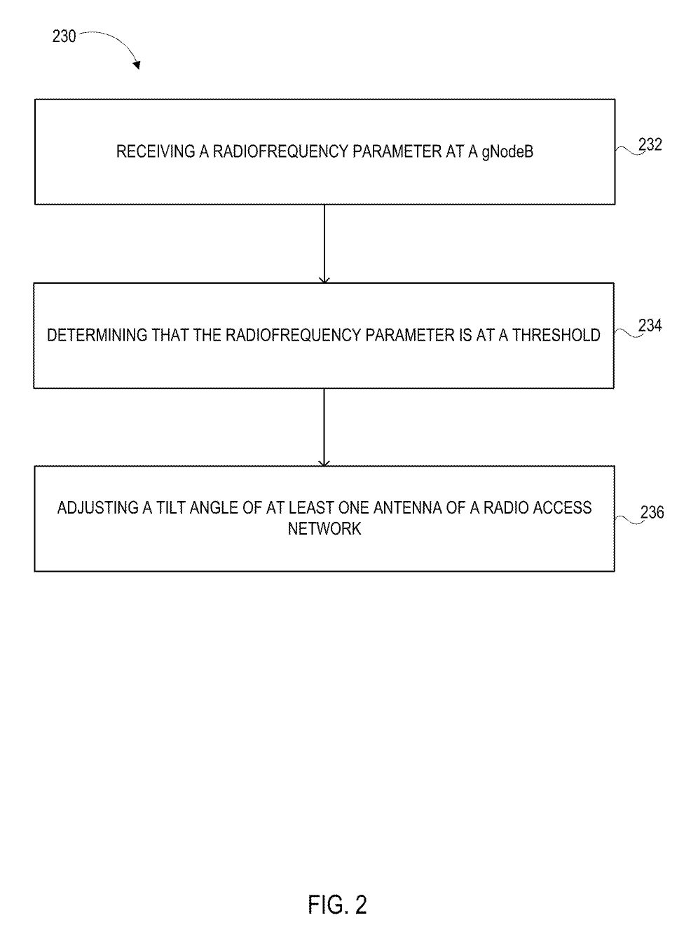

Now referring to FIG. 2, an example method 230 for antenna adjustment in accordance with disclosed embodiments is shown. Method 230 may be performed by any suitable combination of processors discussed herein, for example a processor contained in an IMS.

Method 230 begins at step 232 with receiving a radiofrequency parameter at an access node. The access node may be associated with a particular wireless network and more particularly may be associated with a radio access network (RAN) of the wireless network. The radiofrequency parameter may correspond to a wireless aerial device and may be received at the access node from the wireless aerial device. In some examples, the radiofrequency parameter may comprise a particular network slice to which the wireless aerial device is attached. In such examples, the network slice may be a network slice created by the wireless network and may correspond to a network slice designated for wireless aerial devices. In other examples, the radiofrequency parameter may correspond to an altitude of the wireless aerial device. Further, in some examples, the radiofrequency parameter received at the access node from the wireless device may include both information about the network slice and the altitude of the wireless aerial device. Examples are not so limited, however, and the access node may receive other radiofrequency parameters from the wireless aerial device.

Method 230 continues in step 234 with determining that the radiofrequency parameter satisfies a threshold. More particularly, the radiofrequency parameter received at the access node in step 232 may be compared to a corresponding threshold at the access node. For example, when the radiofrequency parameter received at step 232 is a network slice to which the wireless aerial device is attached, determining that the radiofrequency parameter is at a threshold at step 234 comprises determining that the wireless aerial device is on a particular network slice. Similarly, when the radiofrequency parameter is the altitude of the wireless aerial device, determining that the radiofrequency parameter is at a threshold at step 234 comprises determining that the wireless aerial device has satisfied one or more thresholds, such as altitude. Examples are not so limited, however, and other thresholds may be used, with each threshold corresponding to a particular radiofrequency parameter able to be received at the access node.

At step 236, method 230 includes adjusting a tilt angle of at least one antenna of a RAN. The tilt angle of the at least one antenna may be adjusted in response to the determination that the radiofrequency parameter satisfies a threshold made at step 234. In some examples, adjusting the tilt angle comprises uplifting the tilt angle of the at least one antenna. Said differently, the tilt angle may be increased with respect to the ground, such that the antenna is pointed more away from the ground and more towards a higher altitude.

In some examples, in response to adjusting the tilt angle of the at least one antenna at step 236, a network slice may be established at the access node. The network slice may be designated for use by the wireless aerial device, and as such may include attributes designed to facilitate and enhance connectivity between the wireless aerial device and the cellular network, such as performance conditions. Once the network slice has been established, the wireless aerial device may be attached to the network slice. This may allow the wireless aerial device to maintain its connection with the network and more particularly may allow the wireless aerial device to seamlessly transition to the established network slice once the at least one antenna has had its tilt angle adjusted.

Method 230 may further include uplifting a radiofrequency band. As used herein, a radiofrequency band refers to a particular set of radiofrequencies within the radiofrequency spectrum. Uplifting a radiofrequency band refers to shifting the specific frequencies on the band, which may allow the signal to propagate further. For example, the enhancement may include shifting the specific frequencies to a higher frequency range. In addition, certain radiofrequency bands are more likely to be utilized by cellular network users; thus, uplifting a radiofrequency band which has fewer users may allow a wireless aerial device to have greater access and connectivity at that band. Once the radiofrequency band is uplifted, method 230 may include attaching the wireless aerial device to the uplifted band. As with attaching the wireless aerial device to an established network slice, attaching the wireless aerial device to the uplifted band provided by one or more access nodes of the cellular network may allow the wireless aerial device to maintain its connection with the cellular network while minimizing interruptions.

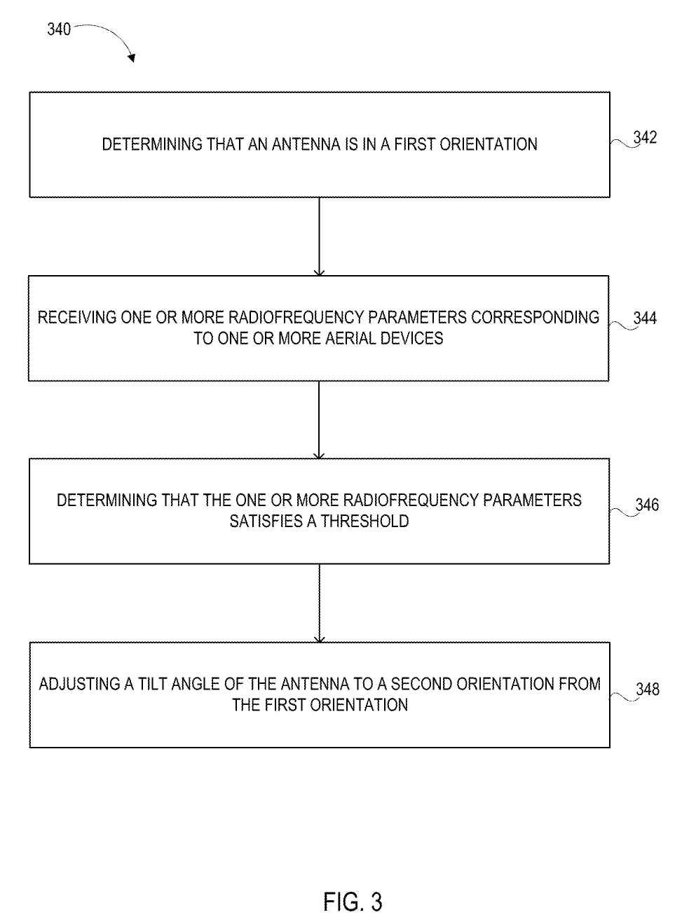

FIG. 3 shows another example method 340 for adjusting a telecommunications antenna in accordance with disclosed embodiments is shown. Method 340 may be performed by any suitable combination of processors discussed herein, for example a processor contained in an IMS.

Method 340 begins at step 342 with determining that an antenna is in a first orientation. The first orientation may correspond to a first tilt angle of the antenna. More particularly, the first orientation may correspond to a tilt angle of the antenna such that the antenna is generally directing wireless signals to ground users on the wireless network.

At step 344, method 340 continues with receiving one or more radiofrequency parameters corresponding to one or more wireless aerial devices. The radiofrequency parameters may be received at an access node. More particularly, the radiofrequency parameters may be received at an access node associated with the wireless network to which the telecommunications antenna belongs. In some examples, the radiofrequency parameter may correspond to a time of day at which the wireless aerial device is being used. In other examples, the radiofrequency parameter may correspond to a usage demand level. The usage demand level may include information about the level of usage on the particular radiofrequency band or network slice being used by the wireless aerial device. In yet other examples, the radiofrequency parameter may correspond to a service level agreement for one or more wireless aerial devices. In addition, multiple radiofrequency parameters may be received at the access node. In addition, examples are not so limited, and other radiofrequency parameters may be received at the access node.

Method 340 continues in step 346 with determining that each of the one or more radiofrequency parameters satisfies a corresponding threshold. The one or more radiofrequency parameters may be received at the access node at step 344. In some examples, determining that each of the one or more radiofrequency parameters satisfies a corresponding threshold comprises receiving a set of information from the one or more wireless aerial devices. The information may be received at the access node and may include the state of at least one wireless aerial device transmitting the information. Upon receiving information from the one or more wireless aerial devices, the access node may compare the received set of information, which includes one or more radiofrequency parameters, to one or more thresholds. For example, when the radiofrequency parameter received at step 344 corresponds to a service level agreement, the information received from the wireless aerial device may relate to the current level of service at the wireless aerial device; thus, the access node is able to compare the level of service at the wireless aerial device with the service level agreement to determine whether the parameter is at a threshold. Examples are not so limited, however, and other information including different radiofrequency parameters may be received at the access node from at least one wireless aerial device. Thus, the access node may compare information received from the wireless aerial device, which includes one or more radiofrequency parameters, with at least one threshold to determine whether the at least one threshold is satisfied.

At step 348, method 340 includes adjusting a tilt angle of the antenna of an access node. More particularly, the tilt angle of the antenna may be adjusted to a second orientation from the first orientation determined at step 342. The tilt angle may be adjusted at step 350 in response to the determination that the radiofrequency parameter satisfies a threshold made at step 346. In some examples, adjusting a tilt angle of the antenna at step 348 may comprise increasing the tilt angle of the antenna with respect to a point on the ground. As a result, the antenna may point relatively less groundward and relatively more skyward.

In some examples, in response to moving the antenna to a second orientation at step 348, method 340 includes uplifting a network band. As described with respect to FIG. 2, uplifting a radiofrequency band refers to enhancing the specific frequencies on the band, allowing the signal to propagate further. For example, the enhancement may include shifting the specific frequencies to a higher frequency range. Once the radiofrequency band is uplifted, method 340 may include attaching a wireless aerial device of the one or more wireless aerial devices to the uplifted band. Attaching a wireless aerial device to the uplifted band provided by one or more access nodes of the cellular network may allow the wireless aerial device to maintain its connection with the cellular network while minimizing interruptions in signal or connectivity between the wireless aerial device and its controller.

In some examples, in response to adjusting the tilt angle of the telecommunication antenna to the second orientation from the first orientation at step 348, method 340 may include establishing a network slice for use by one or more wireless aerial devices. The network slice may include features corresponding to the one or more radiofrequency parameters received at the access node at step 344. For example, the network slice may be established to include latency or transmission standards that correspond to a service level agreement associated with the one or more wireless aerial devices. Once the network slice is established, the wireless aerial device may be attached to the network slice such that the wireless aerial device’s cellular communication and connection goes through the network slice.

Method 340 may further comprise transmitting the determination that a radiofrequency parameter satisfies a radio parameter threshold, made at step 346, to a database. Such transmission may be performed for multiple radiofrequency parameters. The database may be stored at the access node, although examples are not so limited and the database may be stored at another location, such as at a processor of an IMS. The database may include a record of at least two prior determinations of parameter satisfaction, i.e., determinations that the radiofrequency parameter satisfies the radio parameter threshold. Method 340 may then include predicting a subsequent movement of the antenna. The prediction may be based on the record in the database. In some examples, the prediction may be made using machine learning. For example, machine learning may be used to assist in learning patterns surrounding network usage. Such patterns may include times of day or specific areas where wireless aerial devices are likely to be in use and thus connecting to the wireless network. Thus, when patterns are detected, adjustments to the tilt angle of the antenna of an access node may be preemptively made. Moreover, by predicting when adjusting an antenna may be advantageous, steps can be taken to minimize the impact on other users of the wireless network. For example, if an antenna is predicted to benefit from adjustment but there are a number of wireless device users on a particular network band, the network may act to preemptively move the wireless device users to a different band. This may minimize the disruption to the wireless device users that may otherwise be caused when the antenna is adjusted.

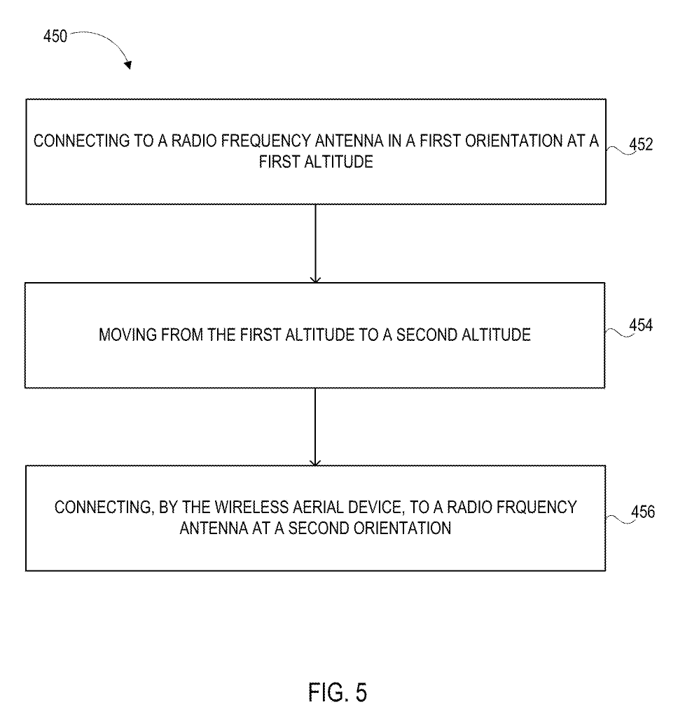

FIG. 4 shows another example method 450 for antenna adjustment in accordance with disclosed embodiments is shown. Method 450 may be performed by any suitable combination of processors discussed herein, for example a processor contained in an IMS.

Method 450 begins at step 452 where a wireless aerial device connects to an antenna. The antenna may be part of an access node of a RAN and may be in a first orientation. The first orientation may correspond to a first tilt angle of the antenna. In some examples, the wireless aerial device may be at a first altitude when the wireless aerial device connects to the antenna.

Method 450 continues in step 454 with the wireless aerial device moving from the first altitude to a second altitude. In some examples, the second altitude is greater than the first altitude, indicating that the wireless aerial device has moved in a generally upward direction. In other examples, the second altitude is less than the first altitude, indicating that the wireless device has moved in a generally downward direction.

At 456, method 450 includes connecting, by the wireless aerial device, to an antenna at a second orientation. The wireless aerial device may connect with the antenna in the second orientation in response to its movement to the second altitude from the first altitude. In some examples, the antenna at the first orientation and the second orientation is the same antenna. Said differently, the wireless aerial device connects to the same antenna at both the first and second altitudes; however, the antenna has changed orientations. More particularly, the antenna may have been moved from a first orientation to a second orientation. The second orientation may comprise different characteristics than the first orientation. For example, in the second orientation, the radiofrequency band may comprise an n71 band, allowing for high-altitude coverage. Examples are not so limited, however, and other bands and/or network slices may be used.

Method 450 may further include transmitting a set of information from the wireless aerial device to an access node. The access node may be associated with the antenna; thus, transmitting information from the wireless aerial device to an access node may provide information about the wireless aerial device and its connection to the antenna. For example, the information transmitted may include the altitude of the wireless aerial device. By transmitting the altitude to the access node, the wireless aerial device may indicate to the access node what its cellular connectivity needs are and what its cellular connectivity needs may be. For instance, if the wireless aerial device transmits a series of altitudes to the access node, and the altitudes are increasing, the access node may determine that an orientation of the radiofrequency antenna may benefit the wireless aerial device. Thus, by transmitting information to an access node, the wireless aerial device may assist the network in maximizing resources for both the wireless aerial device and other users on the network.

In some embodiments, methods 230, 340 and 450 may include additional steps or operations. Furthermore, the methods may include steps shown in each of the other methods. As one of ordinary skill in the art would understand, the methods of 340, 450 and 560 may be integrated in any useful manner and the steps may be performed in any useful sequence.

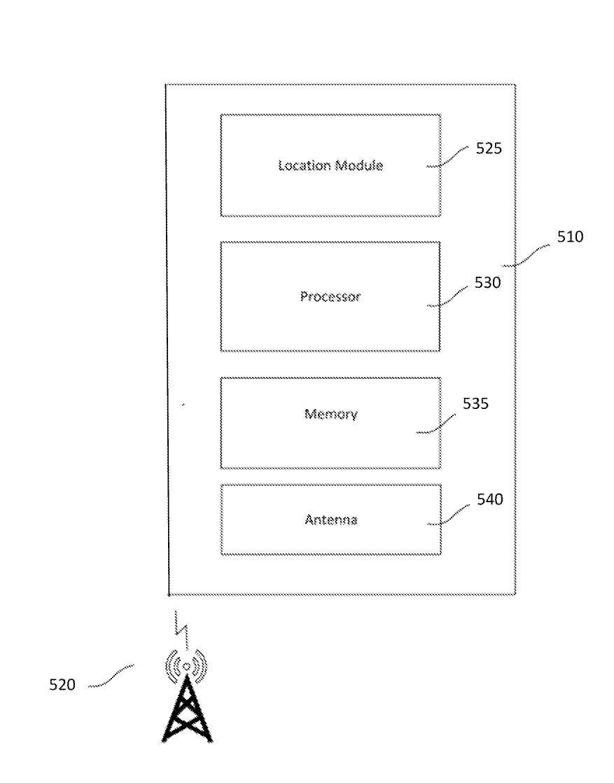

Referring next to FIG. 5, aerial wireless device 510 may be a wireless aerial device having a location module 525, processor 530, memory 535, and antenna 540.

The aerial device 510 may include one or more processors 530 and memory 535 coupled to the one or more processors 330. Further, aerial wireless device 510 may include antenna 540. Antenna 540 may be a radio frequency (RF) antenna, coupled to processor 530. Antenna 540 transmits and receives RF signals. Antenna 540 is capable of transmitting and receiving RF signals from network 520.

Location module 525 determines the location and altitude of wireless device 510. Location module 525 may utilize GPS, antenna patterns, communication patterns, Bluetooth, Wifi and combinations thereof to determine the location of wireless device 510. For example, the location and altitude of the wireless device 510 may be determined by the location module 525 via radio signal triangulation, based on radio signal interference data, based on positioning information reported by the wireless device 510, and/or so forth.

Location module 525 may determine a first altitude, Antenna 540 is connected to a radiofrequency antenna in a first orientation of network 520. Location module 525 tracks changes in altitude, such as aerial wireless device 510 moving from the first altitude to a second altitude. In response aerial wireless device moving from a first altitude to a second altitude, antenna 540 of aerial wireless device 510 connecting an antenna at a second orientation of network 520. In one example, the antenna at the second orientation of network 520 comprises an n71 band for high-altitude coverage.

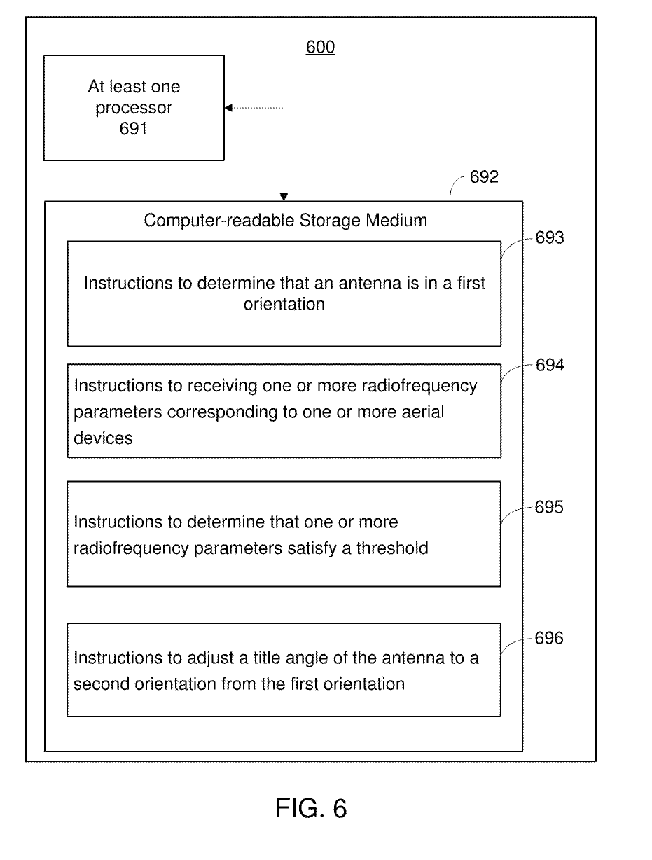

Now referring to FIG. 6, an example computing device 600 is presented. In embodiments, computing device 600 may include a node device, such as devices operating within communication network described in reference to FIG. 1. In this example, computing device 600 includes at least one processor 691 communicably coupled to a computer-readable storage medium 692. The at least one processor 691 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 692. In instances, at least one processor 691 may include electronic circuitry for performing instructions described in this disclosure.

In instances, computer-readable storage medium 692 may be any medium suitable for storing executable instructions. In examples, without limitation, computer-readable storage medium 692 may include read-only memory (ROM), random-access memory (RAM), erasable electrically programmable ROM (EEPROM), Solid State Drive (SSD), optical disc, and the like. Computer-readable medium storage 492 may be disposed within computing device 600. In embodiments, computer-readable storage medium 692 may be external, and communicably connected, to computing device 600. The instruction stored on computer-readable storage medium may be used to implement method steps described in reference to FIG. 3.

In this example, computer-readable storage medium 692 is encoded with a set of instructions 693, 694, 695 and 696. In embodiments, executable instructions included in each block may be included in different blocks shown and blocks not shown.

Instruction 693, when executed by at least one processor 691, configures the at least one processor 691 to determine that an antenna is in a first orientation. The first orientation may correspond to a first tilt angle of the antenna.

Instruction 694, when executed by at least one processor 691, configures the at least one processor 691 to receive one or more radiofrequency parameters. The one or more radiofrequency parameters may correspond to one or more wireless aerial devices. In some examples, the one or more radiofrequency parameters may correspond to a time of day, a usage demand level, and/or a service level agreement for the wireless aerial device. In some examples, the one or more radiofrequency parameters may correspond to an altitude of the wireless aerial device or a connection status of the wireless aerial device.

Instruction 695, when executed by at least one processor 691, configures the at least one processor 691 to determine that the one or more radiofrequency parameters satisfy a threshold. The one or more radiofrequency parameters may correspond to the one or more radiofrequency parameters received at instructions 694. In some examples, the one or more radiofrequency parameters are compared to a threshold radiofrequency parameter. The threshold radiofrequency parameter may be stored at the at least one processor 691.

Instruction 696, when executed by at least one processor 691, configures a second processor of the at least one processor 691 to adjust a tilt angle of the antenna to a second orientation. More particularly, instructions 696 may configure the processor to move the antenna from the first orientation to a second orientation by adjusting a tilt angle of the antenna from a first tilt angle to a second tilt angle.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, comprising:
receiving a radiofrequency parameter at an access node, the radiofrequency parameter corresponding to a wireless aerial device;
determining that the radiofrequency parameter satisfies a threshold; and
responsive to the determination that the radiofrequency parameter satisfies a threshold, adjusting a tilt angle of at least one antenna of a radio access network (RAN).

2. The method of claim 1, further comprising uplifting a radiofrequency band.

3. The method of claim 2, further comprising attaching the wireless aerial device to the uplifted radiofrequency band.

4. The method of claim 1, wherein the radiofrequency parameter comprises a network slice to which the wireless aerial device is attached or an altitude of the wireless aerial device.

5. The method of claim 4, wherein determining that the radiofrequency parameter satisfies a threshold comprises determining that the wireless aerial device is on the network slice or that the aerial device has reached a threshold altitude.

6. The method of claim 1, wherein adjusting a tilt of at least one antenna of a RAN further comprises uplifting the tilt angle of the at least one antenna.

7. The method of claim 1, further comprising:
responsive to adjusting the tilt angle of the at least one antenna, establishing a network slice for use by the wireless aerial device; and
attaching the wireless aerial device to the established network slice.

8. A method, comprising:
determining that an antenna is in a first orientation;
receiving, at an access node, one or more radiofrequency parameters corresponding to one or more wireless aerial devices;
determining that the one or more radiofrequency parameters satisfy at least one threshold; and
responsive to determining that the one or more radiofrequency parameters satisfy the at least one threshold, adjusting a tilt angle of the antenna to a second orientation from the first orientation.

9. The method of claim 8, further comprising:
responsive to moving the antenna to a second orientation, uplifting a network band; and
attaching a wireless aerial device of the one or more wireless aerial devices to the uplifted network band.

10. The method of claim 8, wherein the one or more radiofrequency parameters comprise a time of day, usage demand level, and service level agreements for one or more wireless aerial devices.

11. The method of claim 8, wherein determining that the one or more radiofrequency parameters satisfies the at least one threshold further comprises:
receiving, at the access node, a set of information from the one or more wireless aerial devices that includes the one or more radiofrequency parameters; and
comparing the received set of information to the at least one threshold.

12. The method of claim 8, further comprising responsive to adjusting the tilt angle of the antenna, establishing a network slice for use by one or more wireless aerial devices.

13. The method of claim 8, further comprising transmitting a determination that the one or more radiofrequency parameters satisfy a threshold radiofrequency to a database, wherein the database includes a record of at least two prior determinations of parameter satisfaction.

14. The method of claim 13, further comprising predicting a subsequent movement of the antenna, wherein the prediction is based on the record in the database.

15. A method comprising:
connecting, by a wireless aerial device at a first altitude, to an antenna in a first orientation;
moving the wireless aerial device from the first altitude to a second altitude; and
in response to moving the wireless aerial device from a first altitude to a second altitude, connecting, by the wireless aerial device, to an antenna at a second orientation.

16. The method of claim 15, further comprising transmitting a set of information from the wireless aerial device to an access node associated with the antenna.

17. The method of claim 16, wherein the set of information includes an altitude of the wireless aerial device.

18. The method of claim 15, wherein the antenna at the first and second orientation is the same antenna.

19. The method of claim 18, wherein the antenna has been moved from the first orientation to the second orientation.

20. The method of claim 19, wherein the antenna at the second orientation comprises an n71 band for high-altitude coverage.
